(19) United States
(12) Patent Application Publication
(10) Pub. No.: US 2005/0232404 A1
(43) Pub. Date: Oct. 20, 2005

(54) Method of determining a user presence state

(75) Inventor: Garold B. Gaskill, Camas, WA (US)

Correspondence Address: ROBERT D. VARITZ, 4915 S.E. 33RD PLACE, PORTLAND, OR, 97202, US

(73) Assignee: Sharp Laboratories of America, Inc.

(21) Appl. No.: 10/825,734

(22) Filed: Apr. 15, 2004

(51) Int. Cl. H04M 3/42

(52) U.S. Cl. 379/201.06

(57) ABSTRACT

A method of determining a user presence state includes in a telephonic device, for use by a user to receive and transmit an acoustic wave, detecting orientation of the telephonic device to signal the user's presence state to a caller. The telephonic device may be a headset, wherein the relative orientation of a headset microphone to a headset earpiece determines a user presence state signal to be sent, or the telephonic device may be a handset and the gravitation orientation of the handset determines a user presence state signal to be sent. Exemplar user presence state signal include “Listening and Able to Talk” or “Talking,” “Listening,” “Busy,” and “Gone.”

### FIELD OF THE INVENTION

This invention relates to telephonic handsets and headsets, and specifically to a method of signalling the presence and state of a user by handset/headset orientation.

### BACKGROUND OF THE INVENTION

Analog phone systems indicate “presence” of the called party in several indirect ways. These include a ring but no answer or a busy signal. This information is delivered only when a caller initiates a call to a called party. A ring with no answer or an answer by a telephone answering device does not indicate whether or not the person desired is present and available for communication, nor does it indicate how long it may be before a response is given. An announcement (outgoing message) may be left on the answering machine, but it is rarely convenient to do so.

Even with the advent of EMail, and Instant Messaging (IM), i.e., so called “text chat,” there is still a need to know the status of the person (buddy) receiving the messages. Presence in EMail and text chat is handled by the user entering a status message into a computer, such as “I'm in but busy,” or “I'm on vacation,” etc. The message is made available to all in a “buddy” list. If a user's status message is not entered, or not changed as the user's actual status changes, the caller, or person sending a message, does not know whether the called party is really available to respond quickly or not. Also, with always-on broadband access, the fact that a person is logged into a “text chat” application does not necessarily indicate that the person is truly present and available for communication. There are existing methods that utilize the duration of time where there has been no user interaction with the computer to automatically indicate presence, but these methods are not effective when using a handset or headset. Without the actual knowledge of user's status, the caller may be frustrated, or feel the need to attempt other methods to contact the desired party. In addition, new digital phone technology permits multiple conversations to be handled concurrently, but provides no known methods to indicate presence, and to make handling these new capabilities easy. Hence, it is desirable to know that a person is available (present) to accept a call. The capability is not available with some communication systems today (analog telephony) or requires direct user interaction.

U.S. Pat. No. 6,584,182 B2 for Method and apparatus for communicating data over a telephone line using an acoustic modem, to Brodnick, granted Jun. 24, 2003, permits orientation independent insertion of a handset into a modem cradle.

U.S. Pat. No. 6,377,684 B1 for Telephone headset, to Lucey et al., granted Apr. 23, 2002, describes a headset having a rotating microphone.

U.S. Pat. No. 4,504,701 for Telephone having circuitry for reducing the audio output of the ringing signal, to Lucchesi, granted Mar. 12, 1985, describes a telephone which changes ringing volume based on handset orientation via a gravity switch, but does not provide information about the status of the user.

EP 0365741 B1, for Security Handset, to McClain, granted Dec. 14, 1994, describes a handset which prevents transmission of voice while “on hook,” based on handset orientation.

### SUMMARY OF THE INVENTION

A method of determining a user presence state includes in a telephonic device, for use by a user to receive and transmit an acoustic wave, detecting orientation of the telephonic device to signal the user's presence state to a caller. The telephonic device may be a headset, wherein the relative orientation of a headset microphone to a headset earpiece determines a user presence state signal to be sent, or the telephonic device may be a handset and the gravitation orientation of the handset determines a user presence state signal to be sent. Exemplar user presence state signal include “Listening and Able to Talk” or “Talking,” “Listening,” “Busy,” and “Gone.”

It is an object of the invention to provide an intuitive and/or automatic method for detecting the presence and availability of a user for conversation via the use of the telephone handset or headset.

This summary and objectives of the invention are provided to enable quick comprehension of the nature of the invention. A more thorough understanding of the invention may be obtained by reference to the following detailed description of the preferred embodiment of the invention in connection with the drawings.

### BRIEF DESCRIPTION OF THE DRAWINGS

FIG. 1 depicts various headset/handset orientations which may be incorporated into the method of the invention.

### DETAILED DESCRIPTION OF THE PREFERRED EMBODIMENTS

This invention provides an intuitive and/or automatic method for detecting the presence and availability of a user for conversation via the use of the telephone handset or headset. The method of the invention provides a method using a telephone handset or headset to automatically signal a user presence information, or user's presence state. As used herein, “telephonic device” is a device, such as a headset or handset, which is used to receive and transmit acoustic wave, e.g., which allows the user to hear a speaker through a speaker and to talk to another party through a microphone. For a headset, this includes orientation of the microphone relative to the earpiece speaker, and whether the headset is in place on the head. For a telephone handset this includes orientation of the handset on surfaces, or whether it is being held by the user. These orientations enable the user to easily and intuitively communicate his presence to his communication equipment, and thus to any calling party.

A user's presence, and degree of readiness to participate in a voice conversation, may be specified by the exemplar five user presence states defined in Table 1. More, fewer or other presence states may be defined, as required, within the scope of the method of the invention. For example, some presence states used by current PC based phones include: “on vacation,” “out to lunch,” “just stepped out,” “not available,” “do not disturb,” “off line,” “away,” etc. If the user text entry capability, these more specific messages may be added as information which is sent when the basic presence state information indicates the user is “Gone”. However, for purposes of this description, the following five presence states will be used.

TABLE 1

| User's Presence | |
|---|---|
| State | Explanation |
| Gone | The user is neither present nor available for voice chat. |
| Busy | The user is present but currently busy and not currently |
| | able to chat. |
| Listening | The user is present, listening to the current conversa- |
| | tion but the microphone is off (on mute). |
| Listening & Able | The user is present, listening to the current conversa- |
| to Talk | tion and able to talk. |
| Talking | The user is present, listening to the current conversa- |
| | tion and talking. |

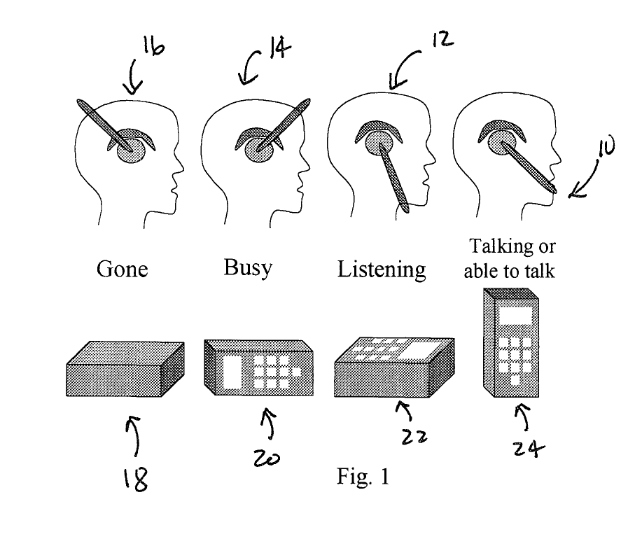

These states are determined for a head set telephone microphone's orientation relative to the earpiece speaker on the ear, and now referring to FIG. 1, as follows:

The orientation of microphone close to the mouth, 10, indicates the user is “Listening and Able to Talk” or “Talking”. In this orientation, the system uses conventional voice activation technology to distinguish between “Talking” and “Listening & Able to Talk”.

The orientation of the microphone in a position below the mouth near the neck, 12, indicate the user is “Listening,” i.e., present, listening to the current conversation but the microphone is off.

The orientation of the microphone in a position near the forehead, 14, indicates the user is “Busy,” i.e., present but currently busy and not currently able to chat.

The orientation of the microphone at the back of the head, 16, indicates the user is “Gone,” possibly for an extended period.

The device for the user's communication equipment to determine the position of the microphone relative to the earpiece speaker could include a standard rotary switch, or many other methods known in the art. Another indication of a “Gone” state includes whether the headset is being worn as indicated by an activated low force micro switch in contact with a location where the head or ear would be if the headset is being worn. Other states may be generated and identified by other positions and orientations as required. However, in keeping with the desire of simple and intuitive operation, it is suggested that the number of positions or orientations be kept to a relatively small number.

For a cordless telephone handset, these states are determined by the handset's orientation relative to a surface as follows:

The handset can be placed face or keypad down on a surface, 18, to indicate the user is “Gone.”

The handset lying on either side, 20, indicates the user is “Busy”

Face or keypad up, 22, indicates “Listening,” i.e., microphone off.

Vertical orientation, 24, indicates “Listening & Able to Talk” or “Talking”. In the vertical orientation, the user state can again be determined by conventional voice activation technology.

The handset may incorporate a standard mercury switch, or a low force micro switch, located on the surfaces of the handset to determine gravitational orientation, e.g., orientation relative to the Earth. A longer time-to-hold in a position may be required if the change is hard to retract, e.g., hang-up, in a conventional telephone. For example a “3-second rule” may apply in that an orientation that results in a hang-up, meaning that the orientation must be held for at least three seconds to take effect, in case the phone is accidentally dropped. Multiple rapid changes in orientation are ignored, or result in a change of user state only after the first change following a “long” period of inactivity, so that unit response time is reduced during “normal” activity. The handset may incorporate manual switches thereon, as part of a manual override mechanism, so that a user may manually set the user's presence state when the user is in a position other than a normal, vertical, orientation. This allows the user to indicate “Listening & Able to Talk” or “Talking” states manually, while allowing the user to recline, lay down, etc., and still be able to talk and not send erroneous user presence state information to a caller. These features may easily be implemented with standard micro-controller technology.

If the user is “Gone” or “Busy,” the voice information of the current caller and other callers is recorded by conventional means, such as a digital telephone answering device, for future play back. If multiple conversations are ongoing, the currently unselected callers are also directed to the recorder. The user's presence states, as a function of the orientation of the headset and handset, along with examples of action taken by a user's communication equipment in response to the presence states, are summarized in Table 2:

TABLE 2

| | Exemplary | | |
|---|---|---|---|
| User's | Methods for | Exemplary Methods | Example of action |
| Presence | Headset to | for Handset to | to take in response |
| State | indicate State | indicate State | to Presence State |
| Gone | Microphone at | Handset face/ | Record all voice |
| | back of head or | buttons down | chat as unheard and |
| | headset not | | indicate “Gone” to |
| | attached | | all callers or poten- |
| | person's | | tail callers |
| | head | | |
| Busy | Microphone at | Handset on either | Record all voice |
| | forehead | side | chat as unheard and |
| | | | indicate “Busy” to |
| | | | all callers or poten- |
| | | | tial callers. |
| Listening | Microphone | Handset face/ | Record selected |
| | below mouth, | buttons up - | user's voice chat as |
| | microphone | microphone off | heard and non |
| | off | (mute) | selected user's voice |
| | | | chat as unheard. |
| | | | Indicate “Listening” |
| | | | to current call and |
| | | | “Busy” to other |
| | | | potential callers. |
| Listening & | Microphone at | [Handset vertical - | Record selected |
| able to talk | mouth, user not | or Handset being | user's voice chat as |
| | talking - (voice | held] and user not | heard and non |
| | activated) | talking - (voice | selected user's voice |
| | | activated). | chat as unheard. |
| | | | Indicate “Mute” to |
| | | | current call and |
| | | | “Busy” to other |
| | | | potential callers. |
| Talking | Microphone at | [Handset vertical | Record selected |
| | mouth, user | or handset being | user's voice chat as |
| | talking - (voice | held] and user | heard and non |
| | activated) | talking - (voice | selected user's voice |
| | | activated) | chat as unheard. |
| | | | “Talking” to current |
| | | | call and “Busy” to |
| | | | other potential |
| | | | callers. |

Having determined the methods of signaling a user's presence status, the information obtained may be presented to the caller, or buddy, in a number of ways. For example, lights or text on the caller's equipment may indicate presence state of the user, brief audio signals, e.g., audio icons, may be used to indicate a transition to a new state. For example, as in current “chat rooms” the sound of a door closing could be an indication of a transition to “Gone,” while the sound of an electric motor running for a few seconds could indicate the user has transitioned to “Busy”. The details of these presentation methods are a matter of choice in the implementation of the method of the invention. The methods to transmit the user's presence status to a calling or potential calling party (buddy) are well known to those of ordinary skill in the art in the voice-over-internet.

Thus, a method of determining a user presence state has been disclosed. It will be appreciated that further variations and modifications thereof may be made within the scope of the invention as defined in the appended claims.

1. A method of determining a user presence state, comprising:
in a telephonic device, for use by a user to receive and transmit an acoustic wave, detecting orientation of the telephonic device to signal the user's presence state.

2. The method of claim 1 wherein the telephonic device is a headset and the relative orientation of a headset microphone to a headset earpiece determines a user presence state signal to be sent.

3. The method of claim 2 wherein the user presence state signal to be sent is taken from the group of user presence state signals consisting of “Listening and Able to Talk” or “Talking” when the orientation of the microphone is close to the mouth; “Listening” when the orientation of the microphone is in a position below the mouth, near the neck; “Busy” when the orientation of the microphone is in a position near the user's forehead; and “Gone” when the orientation of the microphone is at the back of the user's head.

4. The method of claim 1 wherein the telephonic device is a handset and the gravitation orientation of the handset determines a user presence state signal to be sent.

5. The method of claim 4 wherein the user presence state signal to be sent is taken from the group of signals consisting of “Listening and Able to Talk” or “Talking” when the orientation of the handset is vertical; “Listening” when the orientation of the handset is face up; “Busy” when the orientation of the handset is on a side thereof; and “Gone” when the orientation of the handset is face down.

6. The method of claim 4 which includes providing a manual override mechanism on a handset to allow operation by a user not in a vertical orientation.

7. A method of determining a user presence state, comprising:
in a telephonic device, for use by a user to receive and transmit acoustic information, detecting the user's presence via the orientation of the telephonic device relative to gravity.

8. The method of claim 7 where the presence information is sent to all people on a buddy list.

9. The method of claim 7 where the presence information is sent a caller.

10. The method of claim 7 wherein the telephonic device is a headset and the relative orientation of a headset microphone to a headset earpiece determines a user presence state signal to be sent.

11. The method of claim 10 wherein the user presence state signal to be sent is taken from the group of user presence state signals consisting of “Listening and Able to Talk” or “Talking” when the orientation of the microphone is close to the mouth; “Listening” when the orientation of the microphone is in a position below the mouth, near the neck; “Busy” when the orientation of the microphone is in a position near the user's forehead; and “Gone” when the orientation of the microphone is at the back of the user's head.

12. The method of claim 7 wherein the telephonic device is a handset and the gravitation orientation of the handset determines a user presence state signal to be sent.

13. The method of claim 12 wherein the user presence state signal to be sent is taken from the group of signals consisting of “Listening and Able to Talk” or “Talking” when the orientation of the handset is vertical; “Listening” when the orientation of the handset is face up; “Busy” when the orientation of the handset is on a side thereof; and “Gone” when the orientation of the handset is face down.

14. The method of claim 13 which includes providing a manual override mechanism on a handset to allow operation by a user not in a vertical orientation.

15. A method of determining a user presence state, comprising:
in a telephonic device, for use by a user to receive and transmit acoustic information, detecting the user's presence via the orientation of the telephonic device's headset microphone relative to the headset earpiece.

16. The method of claim 15 where the presence information is sent to all people on a buddy list.

17. The method of claim 15 where the presence information is sent a caller.

18. The method of claim 15 wherein the user presence state signal to be sent is taken from the group of user presence state signals consisting of “Listening and Able to Talk” or “Talking” when the orientation of the microphone is close to the mouth; “Listening” when the orientation of the microphone is in a position below the mouth, near the neck; “Busy” when the orientation of the microphone is in a position near the user's forehead; and “Gone” when the orientation of the microphone is at the back of the user's head.
